(19) United States
(12) Patent Application Publication
(10) Pub. No.: US 2025/0060614 A1
(43) Pub. Date: Feb. 20, 2025

(54) EYEGLASSES TEMPLE REPLACEMENT ASSEMBLY

(71) Applicant: PROHERO GROUP CO., LTD., TAINAN CITY (TW)

(72) Inventor: PEN-WEI CHEN, TAINAN CITY (TW)

(21) Appl. No.: 18/449,773

(22) Filed: Aug. 15, 2023

(51) Int. Cl. G02C 5/14

(52) U.S. Cl. CPC G02C 5/146; G02C 2200/08

(57) ABSTRACT

An eyeglasses temple replacement assembly is provided. A frame is pivotally connected with one end of a pivot base and a mounting shaft is projecting from the other end of the pivot base. Two guiding groove are disposed on two sides of the mounting shaft correspondingly while a mounting recess is arranged at an inner end of the mounting shaft corresponding to one side of the guiding groove, and corresponding to the guiding groove. The temple has a mounting hole for mounting the mounting shaft. A mounting block is projecting from each of two sides of the mounting hole and able to move along with the guiding groove and mount into the mounting recess. Thereby the temple selected is connected with the pivot base conveniently and eyeglasses have different styles for aesthetic purposes.

### BACKGROUND OF THE INVENTION

### Field of the Invention

The present invention relates to eyeglasses temple replacement assembly, especially to eyeglasses temple replacement assembly which allows users to change temples with different colors and shapes according to their needs and preferences. Thereby eyeglasses have different styles for aesthetic and visual effects and product competitiveness is improved. Thereby replacement of the eyeglasses temples is more convenient.

### Description of Related Art

Generally, various types of glasses are classified according to their functions or purposes such as optical glasses, sunglasses, sports glasses, and safety glasses. The respective types of glasses have different designs of frames. For example, full frame glasses feature on that lenses are surrounded and held in a frame, making them well-protected. Thus the full frame glasses are usually used in optical glasses with expensive lenses. As to half frame glasses, they are lighter than the full frame glasses. Thus most of light and compact sunglasses, sports glasses and safety glasses are half frame glasses so that users can feel easy and convenient during outdoor activities, sports or construction operations.

No matter which glasses users pick, the design of the glasses includes lenses held in assembly holes of a frame. By threaded fasteners threaded into screw holes beside the assembly holes of the frame, the lenses are held and fixed in the assembly holes of the frame securely. Then temples are pivotally connected with two sides of the frame by pivot members to complete the assembly of the glasses.

Although the above structure provides expected functions by the temples for users to wear, the temples pivotally disposed on the two sides of the frame are unable to be changed easily according to users' needs or preferences. The styles and colors of the temples are flat and dull. Thus product competitiveness of the eyeglasses is unable to be improved effectively and there is room for improvement.

There is a need to provide an eyeglasses temple replacement assembly which improves shortcomings of the structure available now and becomes more convenient to use.

### SUMMARY OF THE INVENTION

Therefore, it is a primary object of the present invention to provide an eyeglasses temple replacement assembly which allows users to change temples with different colors and shapes according to their needs and preferences. Then the temple selected by the user is connected with a pivot base of a frame conveniently. Thereby eyeglasses have different styles for aesthetic and visual effects while being worn and product competitiveness is improved. Therefore, replacement of the eyeglasses temples is more convenient.

In order to achieve the above objects, an eyeglasses temple replacement assembly according to the present invention mainly includes a pivot base and a temple.

One end of the pivot base is pivotally connected with a frame while a mounting shaft is projecting from the other end of the pivot base. Two guiding grooves are disposed on two sides of the mounting shaft correspondingly while a mounting recess is arranged at an inner end of the mounting shaft corresponding to one side of the guiding groove. The guiding groove is communicating with the mounting recess.

The temple consists of a mounting hole located at a front end of the temple and corresponding to the mounting shaft of the pivot base for connected with each other. A mounting block is projecting from each of two sides of the mounting hole and able to be moved along with the guiding groove and mounted into the mounting recess.

Preferably, a positioning locking slot is mounted to a lateral side of the mounting shaft while a positioning bump corresponding to the positioning locking slot is formed in the mounting hole for being locked with and positioned by the positioning locking slot.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing an exploded view of an embodiment according to the present invention;

FIG. 2 is an assembled view of an embodiment before mounting according to the present invention;

FIG. 3 is a sectional view of an embodiment before mounting according to the present invention;

FIG. 4 is an assembled view of an embodiment after mounting according to the present invention; FIG. 5 is a sectional view of an embodiment after mounting according to the present invention;

FIG. 6 is another sectional view of an embodiment after mounting according to the present invention.

### DETAILED DESCRIPTION OF THE PREFERRED EMBODIMENT

In order to learn technical content, features and functions of the present invention more clearly and completely, please refer to the following embodiments with related figures and reference signs.

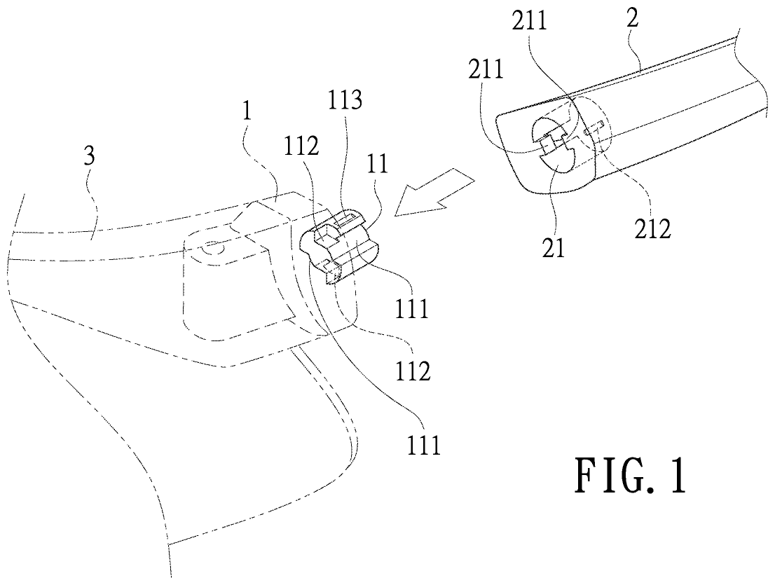

Refer to FIG. 1, an eyeglasses temple replacement assembly according to the present invention mainly includes a pivot base 1 and a temple 2.

One end of the pivot base 1 is pivotally connected with a frame 3 and a mounting shaft 11 is projecting from the other end of the pivot base 1. Two guiding grooves 111 are disposed on two sides of the mounting shaft 11 and corresponding to each other while a mounting recess 112 is arranged at an inner end of the mounting shaft 11 corresponding to one side of the guiding groove 111. The guiding groove 111 is communicating with the mounting recess 112. A positioning locking slot 113 is mounted to a lateral side of the mounting shaft 11.

The temple 2 consists of a front end provided with a mounting hole 21 corresponding to the mounting shaft 11 of the pivot base 1. A mounting block 211 is projecting from each of two sides of the mounting hole 21 while a positioning bump 212 corresponding to the positioning locking slot 113 of the mounting shaft 11 is formed in the mounting hole 21.

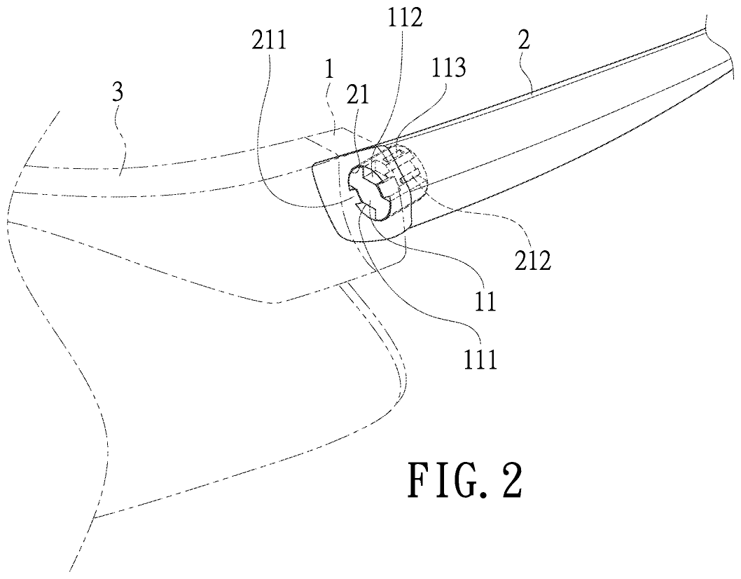

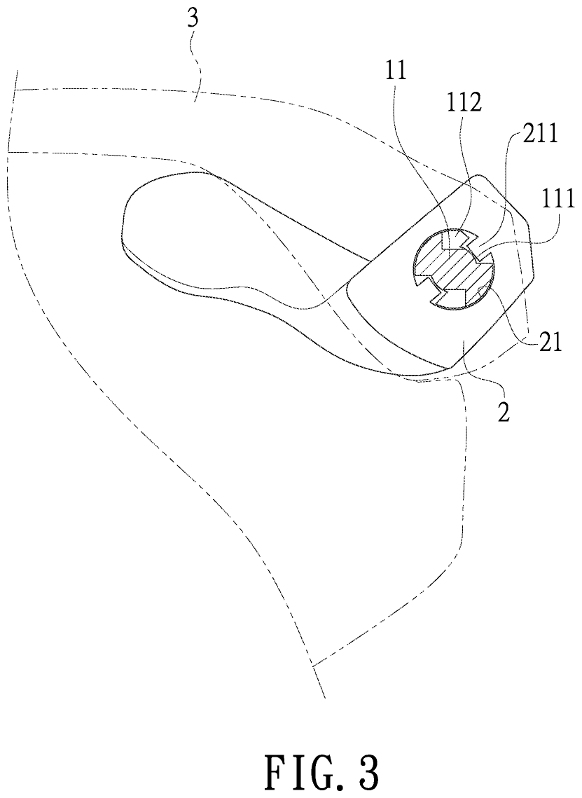

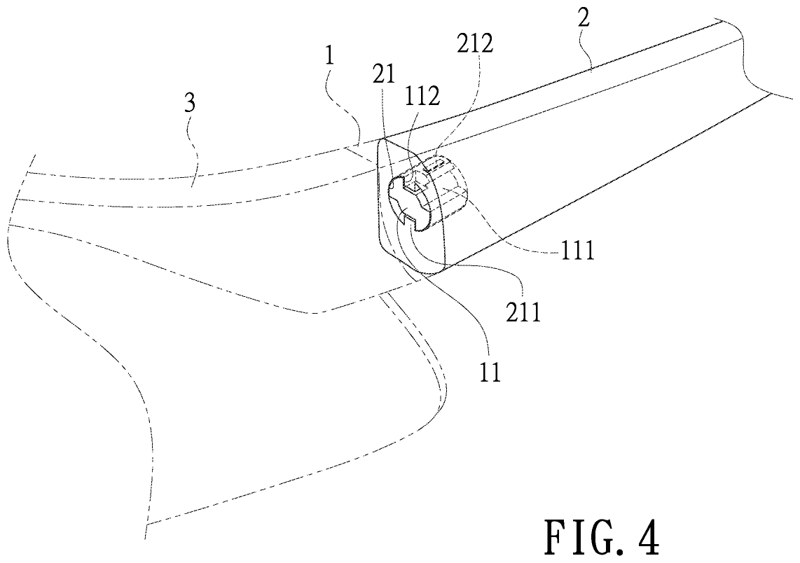

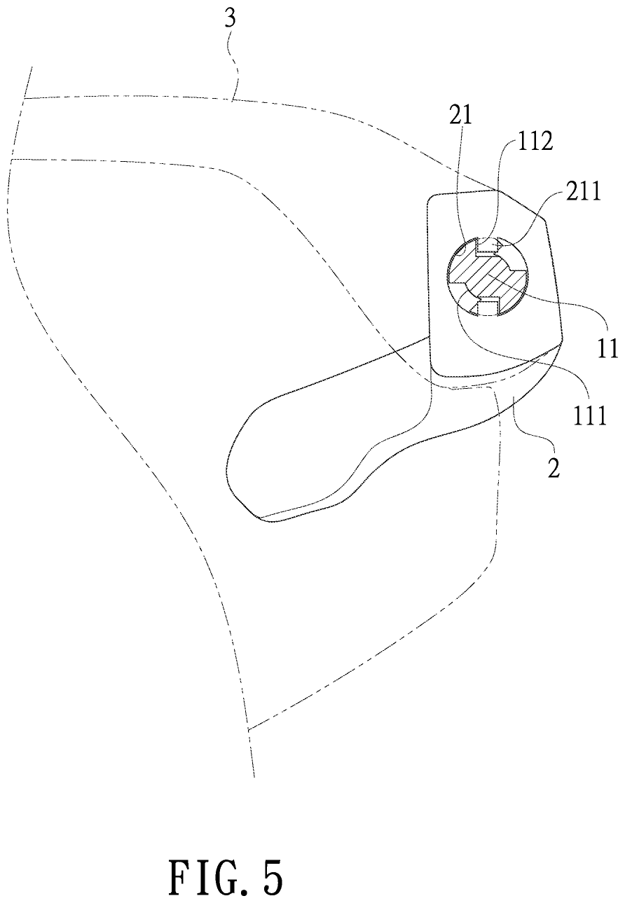

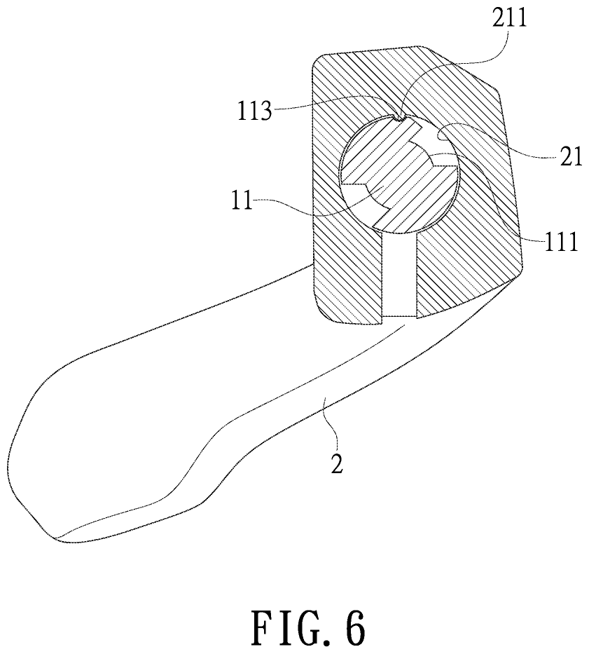

Also refer to FIG. 2 and FIG. 3 which are respectively schematic drawings before mounting. While being assembled, the mounting hole 21 of the temple 2 is corresponding to the mounting shaft 11 of the pivot base 1 and the mounting blocks 211 projecting from the two sides of the mounting hole 21 are aligned with the guiding grooves 111 disposed on the two sides of the mounting shaft 11 correspondingly. The mounting blocks 211 are moved inward along with the guiding grooves 111 so that the mounting shaft 11 is mounted into the mounting hole 21. Then the temple 2 is rotated to make the mounting blocks 211 move laterally into the mounting recesses 112 to be mounted in and connected with the mounting recesses 112 which is communicating with the guiding grooves 111. At the moment, the positioning bump 212 is also locked and positioning in the positioning locking slot 113. Also refer to FIG. 4, FIG. 5, and FIG. 6 after mounting, the temple 2 and the pivot base 1 are precisely connected with and positioned by each other in order to prevent the temple 2 from rotating freely and coming off.

When users intend to replace the temple 2, the temple 2 is rotated reversely and the positioning bump 212 is released from the positioning locking slot 113. The mounting blocks 211 are also moved laterally from the mounting recess 112 to the guiding grooves 111 and then moved outward along with the guiding grooves 111. Thereby the mounting shaft 11 is released from the mounting hole 21 so that the temple 2 and the pivot base 1 are separated from each other. Therefore, the temple 2 can be replaced easily.

In summary, compared with techniques available now, the eyeglasses temple replacement assembly of the present invention allows users to change temples with different colors and shapes according to their needs and preferences. Then the temple selected by the user is connected with a pivot base of a frame conveniently. Thus the eyeglasses have different styles for aesthetic purpose and visual effect while being worn and product competitiveness is improved. Therefore, the eyeglasses temple replacement assembly is more convenient to use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An eyeglasses temple replacement assembly comprising a pivot base and a temple;
wherein one end of the pivot base is pivotally connected with a frame while a mounting shaft is projecting from the other end of the pivot base; two sides of the mounting shaft are provided with two guiding grooves corresponding to each other and a mounting recess is arranged at an inner end of the mounting shaft corresponding to one side of the guiding groove; the guiding groove is communicating with the mounting recess;
wherein the temple includes a mounting hole located at a front end of the temple and corresponding to the mounting shaft of the pivot base for mounting and connected with the mounting shaft; a mounting block is projecting from each of two sides of the mounting hole and able to be moved along with the guiding groove to be mounted into the mounting recess.

2. The eyeglasses temple replacement assembly as claimed in claim 1, wherein a positioning locking slot is mounted to a lateral side of the mounting shaft while a positioning bump corresponding to the positioning locking slot is formed in the mounting hole for being locked with and positioned by the positioning locking slot.
